(19) United States
(12) Patent Application Publication
(10) Pub. No.: US 2012/0307117 A1
(43) Pub. Date: Dec. 6, 2012

(54) SOLID-STATE IMAGING DEVICE

(75) Inventors: Maki SATO, Kanagawa (JP); Toshikazu ODA, Kanagawa (JP)

(73) Assignee: KABUSHIKI KAISHA TOSHIBA, Tokyo (JP)

(21) Appl. No.: 13/368,615

(22) Filed: Feb. 8, 2012

(30) Foreign Application Priority Data
Jun. 2, 2011 (JP) 2011-124210

(51) Int. Cl. H04N 5/335

(52) U.S. Cl. 348/294; 348/E05.091

(57) ABSTRACT

According to one embodiment, a solid-state imaging device includes: a pixel array section in which pixels that accumulate photoelectrically-converted charges are arranged in a matrix shape; and an analog-voltage stabilizing circuit configured to supply, when an analog voltage exceeds a predetermined value, the analog voltage as a power supply voltage for the pixels and supply, when the analog voltage is equal to or smaller than the predetermined value, the analog voltage as the power supply voltage for the pixels after boosting the analog voltage.

### CROSS-REFERENCE TO RELATED APPLICATIONS

This application is based upon and claims the benefit of priority from Japanese Patent Application No. 2011-124210, filed on Jun. 2, 2011; the entire contents of which are incorporated herein by reference.

### FIELD

Embodiments described herein relate generally to a solid-state imaging device.

### BACKGROUND

In a solid-state imaging device, an analog power supply is sometimes directly used as a power supply for pixels. In this case, because the variation in a voltage value of the analog power supply is large, fluctuation in a readout voltage increases and fluctuation in a pixel saturation signal amount increases.

### BRIEF DESCRIPTION OF THE DRAWINGS

FIG. 1 is a block diagram of a schematic configuration of a solid-state imaging device according to a first embodiment;

FIG. 2 is a circuit diagram of a configuration example of a pixel 2 shown in FIG. 1;

FIG. 3 is a flowchart for explaining the operation of an analog-voltage stabilizing circuit 7 shown in FIG. 1;

FIG. 4 is a block diagram of a specific configuration example of the analog-voltage stabilizing circuit 7 shown in FIG. 1;

FIG. 5A is a circuit diagram of a configuration example of a non-hysteresis type comparator;

FIG. 5B is a circuit diagram of a configuration example of a hysteresis type comparator;

FIG. 6A is a diagram of an input output waveform of the non-hysteresis type comparator;

FIG. 6B is a diagram of an input output waveform of the hysteresis type comparator;

FIG. 7 is a block diagram of a schematic configuration of a solid-state imaging device according to a second embodiment; and

FIG. 8 is a block diagram of a schematic configuration of an analog-voltage stabilizing circuit applied to a solid-state imaging device according to a third embodiment.

### DETAILED DESCRIPTION

In general, according to one embodiment, a solid-state imaging device includes a pixel array section and an analog-voltage stabilizing circuit. In the pixel array section, pixels that accumulate photoelectrically-converted charges are arranged in a matrix shape. The analog-voltage stabilizing circuit supplies, when an analog voltage exceeds a predetermined value, the analog voltage as a power supply voltage for the pixels and supplies, when the analog voltage is equal to or smaller than the predetermined value, the analog voltage as the power supply voltage for the pixels after boosting the analog voltage.

Exemplary embodiments are explained below with reference to the accompanying drawings. The present invention is not limited by the embodiments.

### First Embodiment

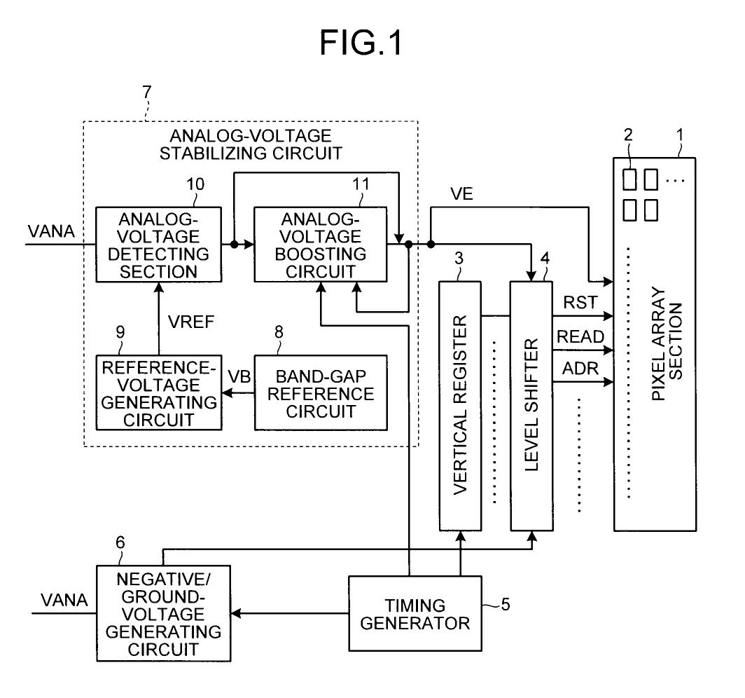

FIG. 1 is a block diagram of a schematic configuration of a solid-state imaging device according to a first embodiment.

In FIG. 1, the solid-state imaging device includes a pixel array section 1 in which pixels 2 that accumulate photoelectrically-converted charges are arranged in a matrix shape in a row direction and a column direction, a vertical register 3 that designates a selected row of the pixel array section 1, a level shifter 4 that generates a driving voltage based on a power supply voltage VE supplied from an analog-voltage stabilizing circuit 7 and applies the driving voltage to the pixels 2 belonging to the selected row, a timing generator 5 that controls timing of readout from and accumulation in the pixels 2, a negative/ground-voltage generating circuit 6 that generates a negative voltage or a ground voltage based on an analog voltage VANA, and the analog-voltage stabilizing circuit 7 that generates the power supply voltage VE based on the analog voltage VANA. In this specification, the analog voltage VANA refers to a voltage for an analog circuit. The driving voltage applied to the pixels 2 can be used as a readout signal READ, a reset signal RST, and a row selection signal ADR.

When the analog voltage VANA exceeds a predetermined value, the analog-voltage stabilizing circuit 7 supplies the analog voltage VANA as the power supply voltage VE for the pixels 2. When the analog voltage VANA is equal to or smaller than the predetermined value, the analog-voltage stabilizing circuit 7 supplies the analog voltage VANA as the power supply voltage VE for the pixels 2 after boosting the analog voltage VANA. The analog-voltage stabilizing circuit 7 includes a band-gap reference circuit 8 that outputs a base voltage VB that depends on a band gap of a semiconductor, a reference-voltage generating circuit 9 that generates a reference voltage VREF based on the base voltage VB, an analog-voltage detecting section 10 that detects a voltage value of the analog voltage VANA, and an analog-voltage boosting circuit 11 that boosts the analog voltage VANA based on an instruction from the analog-voltage detecting section 10. The analog-voltage boosting circuit 11 can be a charge pump circuit or can be a switched capacitor circuit.

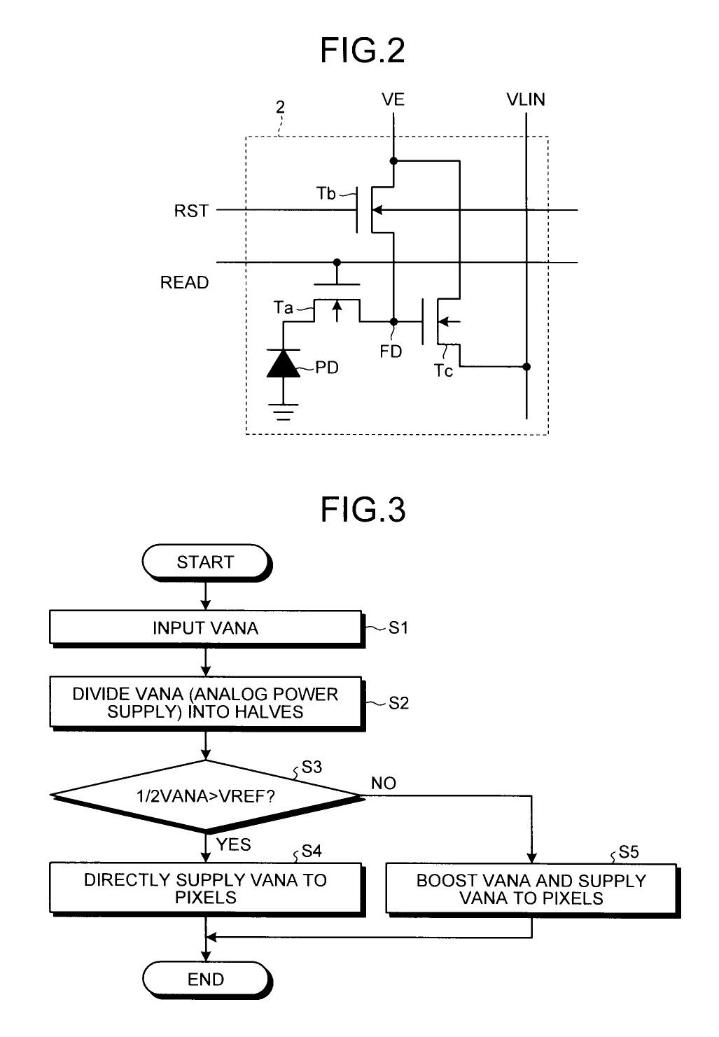

FIG. 2 is a circuit diagram of a configuration example of the pixel 2 shown in FIG. 1.

In FIG. 2, the pixel 2 includes a photodiode PD, a readout transistor Ta, a reset transistor Tb, and an amplification transistor Tc. A floating diffusion FD is formed as a detection node at a connection point of the amplification transistor Tc, the reset transistor Tb, and the readout transistor Ta.

A source of the readout transistor Ta is connected to the photodiode PD. The readout signal READ is input to a gate of the readout transistor Ta. A source of the reset transistor Tb is connected to a drain of the readout transistor Ta. The reset signal RST is input to a gate of the reset transistor Tb. The power supply voltage VE is supplied to a drain of the reset transistor Tb. A source of the amplification transistor Tc is connected to a vertical data line VLIN. A gate of the amplification transistor Tc is connected to the drain of the readout transistor Ta. The power supply voltage VE is supplied to a drain of the amplification transistor Tc.

As the reset transistor Tb, it is desirable to use a depression type transistor. In the example shown in FIG. 2, the configuration not including an address transistor is shown as the pixel 2. However, a pixel including an address transistor to which the row selection signal ADR is input can be used.

The analog voltage VANA is input to the analog-voltage detecting section 10. The analog-voltage detecting section 10 detects a voltage value of the analog voltage VANA. The analog-voltage detecting section 10 determines, by comparing the analog voltage VANA with the reference voltage VREF, whether the analog voltage VANA exceeds the predetermined value. When the analog voltage VANA exceeds the predetermined value, the analog-voltage detecting section 10 supplies the analog voltage VANA to the pixels 2 and the level shifter 4 as the power supply voltage VE.

On the other hand when the analog voltage VANA is equal to or smaller than the predetermined value, the analog-voltage detecting section 10 outputs a result of the determination to the analog-voltage boosting circuit 11.

The analog-voltage boosting circuit 11 boosts the analog voltage VANA to generate the power supply voltage VE and supplies the power supply voltage VE to the pixels 2 and the level shifter 4. When the analog voltage VANA is boosted, it is desirable to set the analog voltage VANA after the boost to about an upper limit value of voltage specifications of the analog voltage VANA. Timing for supplying the analog voltage VANA as the power supply voltage VE for the pixels 2 and the level shifter 4 after boosting the analog voltage VANA is desirably at the head of one frame or immediately after application of a power supply not to affect readout operation from the pixels 2.

The vertical register 3 sequentially selects rows of the pixel array section 1 and informs the level shifter 4 of the selected rows. The level shifter 4 shifts the level of the power supply voltage VE to generate the reset signal RST and the readout signal READ and sequentially applies the reset signal RST and the readout signal READ to the pixels 2 in the selected rows designated by the vertical resister 3.

When the reset signal RST is applied to the pixels 2, the reset transistor Tb is turned on. The potential of the floating diffusion FD is set to the power supply voltage VE via the reset transistor Tb. A reset level at that point is read out to the vertical data line VLIN via the amplification transistor Tc and the reset level is detected from signals of the pixels 2.

Subsequently, when the readout signal READ is applied to the pixels 2, the readout transistor Ta is turned on. Charges accumulated in the photodiode PD is transferred to the floating diffusion FD via the readout transistor Ta. A readout level at that point is read out to the vertical data line VLIN via the amplification transistor Tc. The readout level is detected from the signals of the pixels 2. A difference between the reset level and the readout level is calculated, whereby signal components of the pixels 2 are digitized by a CDS.

In an unselected row at this point, the unselected row is set in a zero set state after the elapse of a readout state at the time when the unselected row is selected last time. In the zero set state, when the unselected row is selected last time, the reset signal RST is applied to the reset transistor Tb and the power supply voltage VE is once dropped to the ground potential. As a result, the reset transistor Tb is turned on and the potential of the floating diffusion FD is set to the ground potential via the reset transistor Tb. Therefore, the amplification transistor Tc of the unselected row is turned off. A signal is prevented from being read out from the unselected row to the vertical data line VLIN.

It is possible to suppress an increase in size of a power supply circuit by using the analog power supply VANA as a power supply for pixels. By boosting the analog power supply VANA according to a voltage value of the analog power supply VANA, it is possible to stably supply the power supply for pixels even when fluctuation in the analog power supply VANA is large. Therefore, it is possible to suppress an increase in fluctuation in a pixel saturation signal amount.

When the analog voltage VANA exceeds the predetermined value, by directly supplying the analog voltage VANA as the power supply voltage VE for the pixels 2, it is possible to prevent noise caused in the analog-voltage stabilizing circuit 7 from being superimposed on the power supply voltage VE. Therefore, it is possible to stabilize a pixel characteristic.

By using a depression type transistor as the reset transistor Tb, even when the power supply voltage VE is supplied to the drain of the reset transistor Tb, it is possible to turn on the reset transistor Tb without boosting the level of the reset signal RST to a voltage larger than the power supply voltage VE. Therefore, it is possible to suppress an increase in size of the level shifter 4.

In the example explained in the embodiment shown in FIG. 1, the power supply voltage VE is shared between the drain of the reset transistor Tb and the drain of the amplification transistor Tc. However, the power supply voltage VE can be divided between the drain of the reset transistor Tb and the drain of the amplification transistor Tc. In this case, analog-voltage boosting circuits 11 can be separately provided for the drain of the reset transistor Tb and the drain of the amplification transistor Tc.

FIG. 3 is a flowchart for explaining the operation of the analog-voltage stabilizing circuit 7 shown in FIG. 1.

In FIG. 3, when the analog voltage VANA is input to the analog-voltage detecting section 10 (S1), the analog voltage VANA is divided into halves by a method such as resistance voltage division (S2).

Subsequently, the analog-voltage detecting section 10 compares a divided voltage value of the analog voltage VANA and the reference voltage VREF (S3) and detects whether the analog voltage VANA reaches a necessary voltage. When the divided voltage value of the analog voltage VANA exceeds the reference voltage VREF, the analog-voltage detecting section 10 supplies the analog voltage VANA to the pixels 2 and the level shifter 4 as the power supply voltage VE (S4).

On the other hand, when the divided voltage value of the analog voltage VANA is equal to or smaller than the reference voltage VREF, the analog-voltage boosting circuit 11 boosts the analog voltage VANA to generate the power supply voltage VE and supplies the power supply voltage VE to the pixels 2 and the level shifter 4 (S5).

For example, the analog voltage VANA has power supply specifications of 2.3 volts to 2.8 volts. Actually, the analog voltage VANA of 2.4 volts is supplied from the outside. In this case, for example, if the reference voltage VREF is 1.35 volts, 1/2VANA=1.2V is lower than the reference voltage VREF. Therefore, the analog-voltage boosting circuit 11 can boost the analog voltage VANA from 2.4 volts to 2.8 volts and supply the analog voltage VANA to the pixels 2 and the level shifter 4.

When the analog voltage VANA of 2.7 volts is supplied from the outside, 1/2VANA=1.36V exceeds the reference voltage VREF. Therefore, it is possible to directly supply the analog voltage VANA to the pixels 2 and the level shifter 4 without boosting the analog voltage VANA with the analog-voltage boosting circuit 11. Consequently, even when power supply specifications of the analog voltage VANA are 2.3 volts to 2.8 volts, it is possible to suppress the fluctuation in the power supply voltage VE between 2.7 volts and 2.8 volts and suppress fluctuation in a pixel power supply.

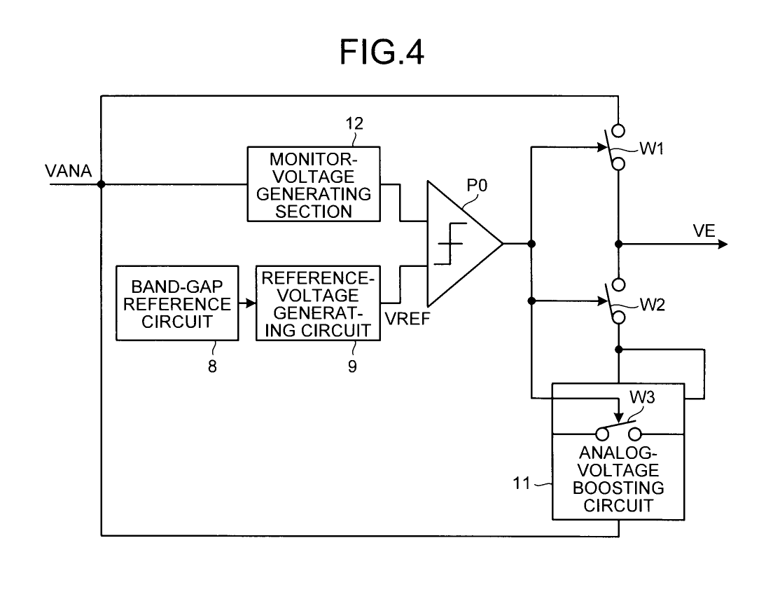

FIG. 4 is a block diagram of a specific configuration example of the analog-voltage stabilizing circuit 7 shown in FIG. 1.

In FIG. 4, the analog-voltage stabilizing circuit 7 includes the band-gap reference circuit 8, the reference-voltage generating circuit 9, the analog-voltage boosting circuit 11, a monitor-voltage generating section 12, a hysteresis type comparator P0, and switches W1 and W2. The analog voltage boosting circuit 11 includes a switch W3.

The monitor-voltage generating section 12 can generate a monitor voltage based on the analog voltage VANA. As a method of generating the monitor voltage, for example, resistance voltage division for the analog voltage VANA can be used. The hysteresis type comparator P0 can compare the monitor voltage generated by the monitor-voltage generating section 12 with the reference voltage VREF. The switches W1 to W3 can turn on and off the output of the analog voltage VANA based on an output of the hysteresis type comparator P0. When the analog voltage VANA is input to the monitor-voltage generating section 12, the monitor-voltage generating section 12 divides the analog voltage VANA to thereby generate a monitor voltage and outputs the monitor voltage to the hysteresis type comparator P0.

The hysteresis type comparator P0 compares the monitor voltage with the reference voltage VREF. When the monitor voltage exceeds the reference voltage VREF, the switch W1 is turned on, whereby the analog voltage VANA is supplied to the pixels 2 and the level shifter 4 as the power supply voltage VE.

On the other hand, when the monitor voltage is equal to or smaller than the reference voltage VREF, the switches W2 and W3 are turned on, whereby the analog-voltage boosting circuit 11 boosts the analog voltage VANA and supplies the analog voltage VANA to the pixels 2 and the level shifter 4 as the power supply voltage VE.

To match a voltage output from the analog-voltage boosting circuit 11 with a setting value, a monitor circuit that monitors an output of the analog-voltage boosting circuit 11 can be provided. The output of the analog-voltage boosting circuit 11 can be controlled based on a result of the monitoring.

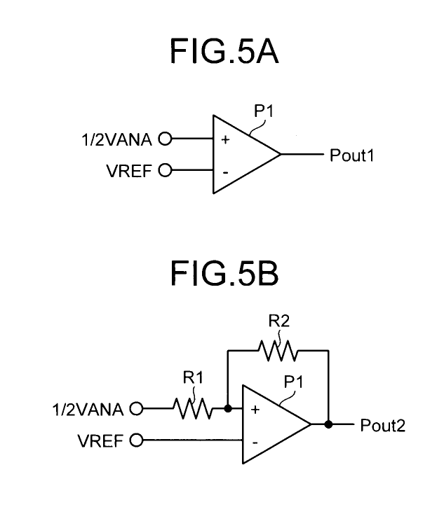

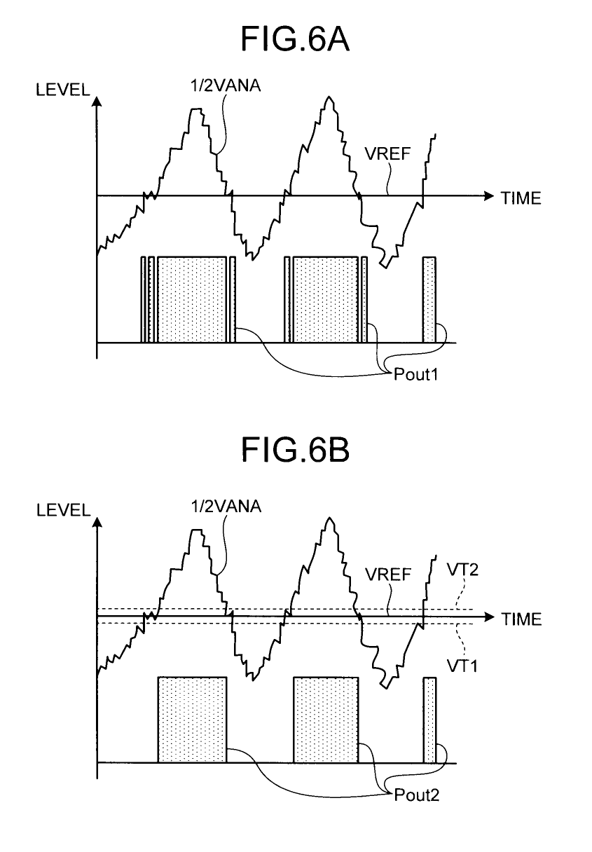

FIG. 5A is a circuit diagram of a configuration example of a non-hysteresis type comparator. FIG. 5B is a circuit diagram of a configuration example of a hysteresis type comparator. FIG. 6A is a diagram of an input output waveform of the non-hysteresis type comparator. FIG. 6B is a diagram of an input output waveform of the hysteresis type comparator.

In FIG. 5A, a non-hysteresis type comparator P1 compares 1/2VANA and VREF. As shown in FIG. 6A, if noise is superimposed on the analog voltage VANA, the analog voltage VANA fluctuates around the reference voltage VREF. An output Pout1 of the non-hysteresis type comparator P1 becomes unstable.

On the other hand, in FIG. 5B, an input resistor R1 and a feedback resistor R2 are added to the non-hysteresis type comparator P1 to configure the hysteresis type comparator P0. The hysteresis type comparator P0 sets two thresholds VT1 and VT2. If the hysteresis type comparator P0 compares 1/2VANA and VREF, when 1/2VANA is between the thresholds VT1 and VT2, inversion of an output Pout2 of the hysteresis type comparator P0 is prevented. Therefore, even when the analog voltage VANA fluctuates around the reference voltage VREF, as shown in FIG. 6B, the output Pout2 of the hysteresis type comparator P0 becomes stable.

### Second Embodiment

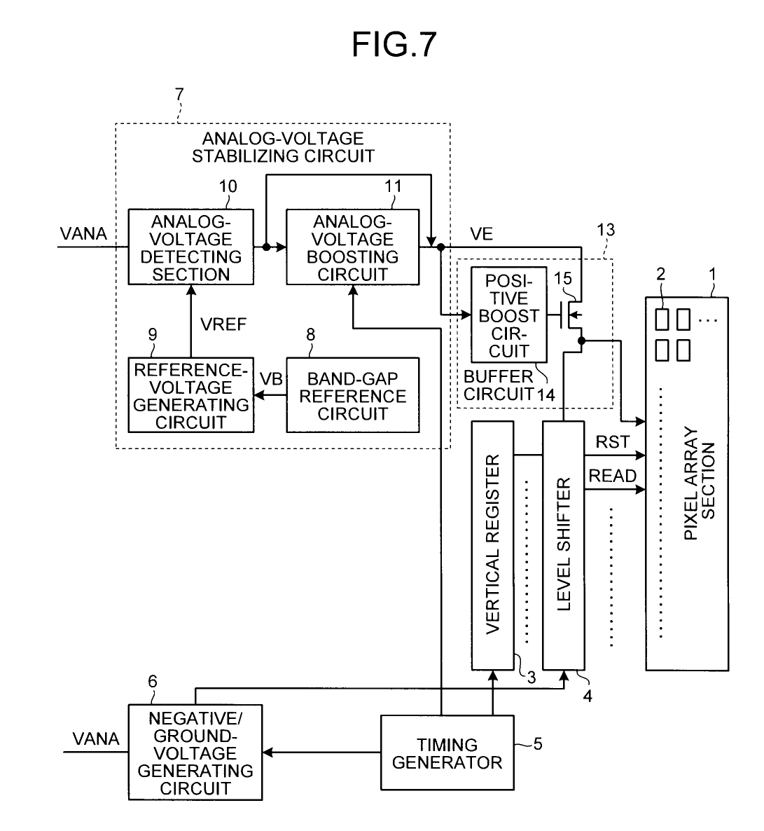

FIG. 7 is a block diagram of a schematic configuration of a solid-state imaging device according to a second embodiment.

In FIG. 7, in the solid-state imaging device, a buffer circuit 13 is added to the configuration shown in FIG. 1. The buffer circuit 13 can reduce fluctuation due to noise in the power supply voltage VE supplied from the analog-voltage stabilizing circuit 7. The buffer circuit 13 includes a buffer transistor 15 and a positive boost circuit 14. As the buffer transistor 15, for example, an N-channel field effect transistor can be used.

The buffer transistor 15 can receive the power supply voltage VE, which is supplied from the analog-voltage stabilizing circuit 7, as a drain voltage and supply a source voltage to the pixels 2 and the level shifter 4.

The positive boost circuit 14 boosts the power supply voltage VE by a threshold voltage of the buffer transistor 15 and supplies the power supply voltage VE to a gate of the buffer transistor 15.

When the power supply voltage VE from the analog-voltage stabilizing circuit 7 is supplied to a drain of the buffer transistor 15, the power supply voltage VE is output to the pixels 2 and the level shifter 4 from a source of the buffer transistor 15 according to the source follower operation of the buffer transistor 15.

The buffer transistor 15 receives the power supply voltage VE, which is supplied from the analog-voltage stabilizing circuit 7, as a drain voltage and supplies a source voltage to the pixels 2 and the level shifter 4 via the source follower operation between the gate and the source of the buffer transistor 15. This makes it possible to reduce noise of the power supply voltage VE supplied to the pixels 2 and the level shifter 4 and stabilize a pixel characteristic.

To reduce noise of a voltage supplied from the positive boost circuit 14 to the gate of the buffer transistor 15, for example, a capacitor can be added to the positive boost circuit 14 to apply the voltage to the gate of the buffer transistor 15 after removing a ripple or the like. A part of the analog-voltage boosting circuit 11 can be diverted to configure the positive boost circuit 14.

### Third Embodiment

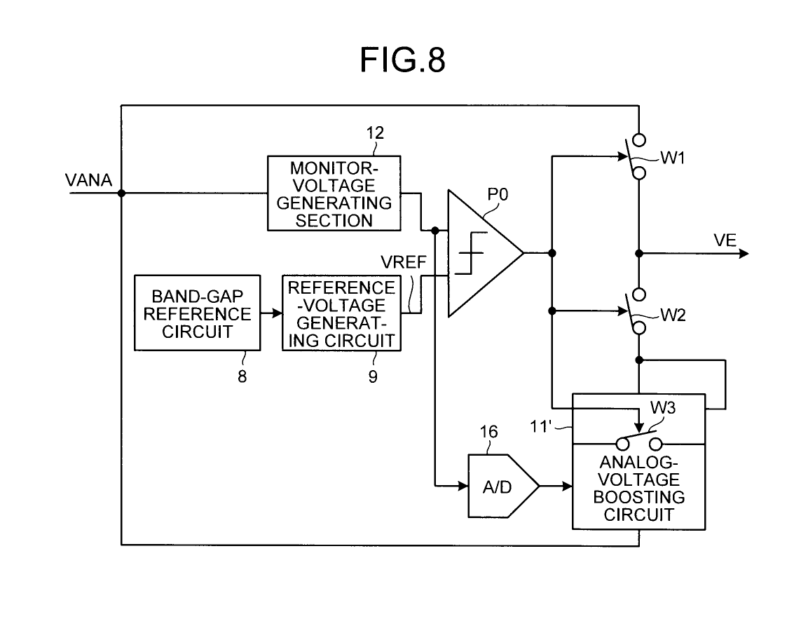

FIG. 8 is a block diagram of a schematic configuration of an analog-voltage stabilizing circuit applied to a solid-state imaging device according to a third embodiment.

In FIG. 8, in the solid-state imaging device, an A/D converter 16 is added to the configuration shown in FIG. 4 and an analog-voltage boosting circuit 11′ is provided instead of the analog-voltage boosting circuit 11. The A/D converter 16 can A/D-convert a monitor voltage output from the monitor-voltage generating section 12 and output the monitor voltage to the analog-voltage boosting circuit 11′. The analog-voltage boosting circuit 11′ can adjust driving force based on the output of the A/D converter 16.

Specifically, the analog-voltage boosting circuit 11′ can estimate the magnitude of the analog voltage VANA based on the output of the A/D converter 16. When the analog voltage VANA is large, the analog-voltage boosting circuit 11′ can reduce the driving force of the analog-voltage boosting circuit 11′. When the analog voltage VANA is small, the analog-voltage boosting circuit 11′ can increase the driving force of the analog-voltage boosting circuit 11′.

In the embodiment shown in FIG. 8, a method of inputting the monitor voltage, which is output from the monitor-voltage generating section 12, to the A/D converter 16 is explained. However, the analog voltage VANA can be input to the A/D converter 16.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array section in which pixels that accumulate photoelectrically-converted charges are arranged in a matrix shape; and
an analog-voltage stabilizing circuit configured to supply, when an analog voltage exceeds a predetermined value, the analog voltage as a power supply voltage for the pixels and supply, when the analog voltage is equal to or smaller than the predetermined value, the analog voltage as the power supply voltage for the pixels after boosting the analog voltage.

2. The solid-state imaging device according to claim 1, further comprising:
a vertical register configured to designate a selected row of the pixel array section; and
a level shifter configured to generate a driving voltage based on the power supply voltage supplied from the analog-voltage stabilizing circuit and apply the driving voltage to the pixels belonging to the selected row.

3. The solid-state imaging device according to claim 1, wherein
the pixel includes:
a photodiode configured to perform photoelectric conversion;
a detection node configured to detect a signal corresponding to charges accumulated in the photodiode;
a readout transistor configured to read out the charges accumulated in the photodiode to the detection node;
an amplification transistor configured to amplify the signal detected by the detection node; and
a reset transistor configured to reset the detection node, and
the reset transistor includes a depression type transistor.

4. The solid-state imaging device according to claim 1, wherein
the analog-voltage stabilizing circuit includes:
an analog-voltage detecting section configured to detect a voltage value of the analog voltage; and
an analog-voltage boosting circuit configured to boost the analog voltage based on an instruction from the analog-voltage detecting section.

5. The solid-state imaging device according to claim 1, wherein
the analog-voltage stabilizing circuit includes:
a monitor-voltage generating section configured to generate a monitor voltage based on the analog voltage;
a comparator configured to compare the monitor voltage and a reference voltage; and
an analog-voltage boosting circuit configured to boost the analog voltage based on a comparison result of the comparator.

6. The solid-state imaging device according to claim 5, wherein
the analog-voltage stabilizing circuit includes:
a band-gap reference circuit configured to output a base voltage that depends on a band gap of a semiconductor; and
a reference-voltage generating circuit configured to generate the reference voltage based on the base voltage.

7. The solid-state imaging device according to claim 6, wherein
the analog-voltage stabilizing circuit includes:
a first switch configured to supply the analog voltage as the power supply voltage for the pixels based on the comparison result of the comparator; and
a second switch configured to supply a boosted voltage of the analog voltage as the power supply voltage for the pixels based on the comparison result of the comparator.

8. The solid-state imaging device according to claim 7, further comprising a third switch configured to supply the analog voltage to the analog-voltage boosting circuit based on the comparison result of the comparator.

9. The solid-state imaging device according to claim 5, wherein the comparator is a hysteresis type comparator.

10. The solid-state imaging device according to claim 9, wherein
the hysteresis type comparator includes:
a non-hysteresis type comparator;
an input resistor connected to the non-hysteresis type comparator; and
a feedback resistor connected to the non-hysteresis type comparator.

11. The solid-state imaging device according to claim 5, further comprising an A/D converter configured to A/D-convert the monitor voltage, wherein
the analog-voltage boosting circuit adjusts driving force based on an output of the A/D converter.

12. The solid-state imaging device according to claim 11, wherein the analog-voltage boosting circuit reduces the driving force of the analog-voltage boosting circuit when the analog voltage is large and increases the driving force of the analog-voltage boosting circuit when the analog voltage is small.

13. The solid-state imaging device according to claim 1, wherein timing for supplying the analog voltage as the power supply voltage for the pixels after boosting the analog voltage is at a head of one frame or immediately after application of a power supply.

14. The solid-state imaging device according to claim 1, further comprising a buffer transistor configured to output the power supply voltage, which is supplied from the analog-voltage stabilizing circuit, from a source as a drain voltage.

15. The solid-state imaging device according to claim 14, wherein the buffer transistor performs source follower operation.

16. The solid-state imaging device according to claim 15, wherein the buffer transistor is an N-channel field effect transistor.

17. The solid-state imaging device according to claim 16, further comprising a positive boost circuit configured to boost the power supply voltage by a threshold voltage of the buffer transistor and supply the power supply voltage to a gate of the buffer transistor.

18. A solid-state imaging device comprising:
a pixel array section in which pixels that accumulate photoelectrically-converted charges are arranged in a matrix shape;
an analog-voltage stabilizing circuit configured to supply an analog voltage as a power supply voltage for the pixels after stabilizing the analog voltage; and
a buffer transistor configured to output the power supply voltage, which is supplied from the analog-voltage stabilizing circuit, from a source as a drain voltage.

19. The solid-state imaging device according to claim 18, wherein the buffer transistor performs source follower operation.

20. The solid-state imaging device according to claim 19, wherein the buffer transistor is an N-channel field effect transistor.
